(19) United States
(12) Patent Application Publication
(10) Pub. No.: US 2025/0384334 A1
(43) Pub. Date: Dec. 18, 2025

(54) COMPUTING SYSTEMS AND METHODS FOR A UNIFIED MACHINE LEARNING PIPELINE WITH AN ARTIFACT ADAPTER

(71) Applicant: The Toronto-Dominion Bank, Toronto (CA)

(72) Inventors: Peter STARSZYK, Waterloo (CA); Anuar YERALIYEV, Toronto (CA); Satya Krishna GORTI, Toronto (CA); Keyvan GOLESTAN IRANI, Aurora (CA); Alexander CLARENCE, Toronto (CA); Kin Kwan LEUNG, Toronto (CA); Devinder KUMAR, Toronto (CA); Raunaq SURI, Mississauga (CA); Guangwei YU, Toronto (CA); Maksims VOLKOVS, Toronto (CA)

(21) Appl. No.: 18/745,411

(22) Filed: Jun. 17, 2024

(51) Int. Cl. G06N 20/00

(52) U.S. Cl. CPC G06N 20/00

(57) ABSTRACT

Systems and methods are provided for a machine learning (ML) pipeline with a unified framework. A training data adapter receives training data in a training data format, processes the training data to match a pipeline data format of a machine learning pipeline, and transmits reformatted training data to the machine learning pipeline. The machine learning pipeline receives and processes the reformatted training data to train a machine learning model in the machine learning pipeline in a development environment, and further executes the machine learning model in a production environment. An artifact adapter receives training artifacts that were produced while training the machine learning model, and processes the training artifacts to update the machine learning model in the machine learning pipeline.

### TECHNICAL FIELD

The disclosed exemplary embodiments relate to computer-implemented systems and methods for a unified machine learning pipeline with an artifact adapter.

### BACKGROUND

A machine learning (ML) pipeline is a series of interconnected data processing and modelling modules to automate machine learning computing processes, which are applicable to machine learning models and artificial intelligence models. A machine learning pipeline is developed for training a machine learning model or an artificial intelligence model. In the context of training, a machine learning pipeline includes modules for data collection, data cleaning, feature extraction, feature generation, training and validation. After the machine learning model or the artificial intelligence model has been trained, then another machine learning pipeline is established for deployment that uses the trained machine learning model or the trained artificial intelligence model.

### SUMMARY

The following summary is intended to introduce the reader to various aspects of the detailed description, but not to define or delimit any invention.

In at least one broad aspect, a cloud computing system for machine learning is provided. The cloud computing system comprises:
a training data adapter configured to receive training data in a training data format, process the training data to match a pipeline data format of a machine learning pipeline, and transmit reformatted training data to the machine learning pipeline;
the machine learning pipeline comprising a pipeline virtual computing machine configured to receive and process the reformatted training data to train a machine learning model in the machine learning pipeline in a development environment, and further configured to execute the machine learning model in a production environment;
an artifact adapter configured to receive training artifacts that were produced while training the machine learning model, and process the training artifacts to update the machine learning model in the machine learning pipeline;
wherein, when the training data adapter and the machine learning pipeline are in communication with each other, the machine learning pipeline automatically determines that the reformatted training data is for training the machine learning model in the development environment; and
wherein, when the artifact adapter and the machine learning pipeline are in communication with each other, the machine learning pipeline automatically determines that the processing of the training artifacts to update the machine learning model occurs in the development environment.

In some cases, the machine learning pipeline is configured to synchronize logged data from the development environment and logged data from the production environment; and wherein the logged data from the development environment comprises the training artifacts, and the logged data from the production environment comprises production artifacts generated by the machine learning model.

In some cases, the cloud computing system further comprises a training data logger in the development environment and in communication with the machine learning pipeline, the training data logger configured to store the training artifacts.

In some cases, the training data logger transmits back the training artifacts to the artifact adapter.

In some cases, the cloud computing system further comprises: a production data adapter comprising a production virtual computing machine configured to receive production data in a production data format, process the production data to match the pipeline data format, and transmit reformatted production data to the machine learning pipeline; wherein the machine learning pipeline is further configured to receive and process the reformatted production data using the machine learning model to generate production artifacts in the production environment; and wherein, when the production data adapter and the machine learning pipeline are in communication with each other, the machine learning pipeline automatically determines that the reformatted production data is to be inputted into the machine learning model in the production environment.

In some cases, the cloud computing system further comprises a production data logger in the production environment and in communication with the machine learning pipeline, the production data logger configured to asynchronously store the production artifacts.

In some cases, the production environment is a real-time inferencing environment, the production data comprises a real-time request, and the production artifacts are real-time inferencing artifacts that are saved asynchronously into a memory of the production data logger.

In some cases, the real-time request is a Hypertext Transfer Protocol (HTTP) request, and the real-time inferencing artifacts are processed to generate an HTTP response.

In some cases, the cloud computing system further comprises: a testing data adapter comprising a testing virtual computing machine configured to receive a batch dataset in a testing data format, process the batch dataset to match the pipeline data format of the machine learning pipeline, and transmit a reformatted batch dataset to the machine learning pipeline; the machine learning pipeline further configured to receive and process the reformatted batch dataset to test the machine learning model; and wherein, when the testing data adapter and the machine learning pipeline are in communication with each other, the machine learning pipeline automatically determines that the reformatted testing data is for testing the machine learning model in a batch inferencing environment.

In some cases, the machine learning pipeline is further configured to process the reformatted batch dataset using the machine learning model in the batch inferencing environment to generate batch inference artifacts.

In at least another broad aspect, a method for machine learning is provided. The method is executed in a computing environment comprising one or more processors, a communication interface, and memory, and the method comprises:
a training data adapter receiving training data in a training data format, processing the training data to match a pipeline data format of a machine learning pipeline, and transmitting reformatted training data to the machine learning pipeline;
the machine learning pipeline receiving and processing the reformatted training data to train a machine learning model in the machine learning pipeline in a development environment, and further executing the machine learning model in a production environment;
an artifact adapter receiving training artifacts that were produced while training the machine learning model, and processing the training artifacts to update the machine learning model in the machine learning pipeline;
wherein, when the training data adapter and the machine learning pipeline are in communication with each other, the machine learning pipeline automatically determines that the reformatted training data is for training the machine learning model in the development environment; and
wherein, when the artifact adapter and the machine learning pipeline are in communication with each other, the machine learning pipeline automatically determines that the processing of the training artifacts to update the machine learning model occurs in the development environment.

In some cases, the method further comprises the machine learning pipeline synchronizing logged data from the development environment and logged data from the production environment; and wherein the logged data from the development environment comprises the training artifacts, and the logged data from the production environment comprises production artifacts generated by the machine learning model.

In some cases, the method further comprises a training data logger storing the training artifacts, wherein the training data logger is.in the development environment and in communication with the machine learning pipeline.

In some cases, the method further comprises the training data logger transmitting back the training artifacts to the artifact adapter.

In some cases, the method further comprises: a production data adapter receiving production data in a production data format, processing the production data to match the pipeline data format, and transmitting reformatted production data to the machine learning pipeline; the machine learning pipeline receiving and processing the reformatted production data using the machine learning model to generate production artifacts in the production environment; and wherein, when the production data adapter and the machine learning pipeline are in communication with each other, the machine learning pipeline automatically determines that the reformatted production data is to be inputted into the machine learning model in the production environment.

In some cases, the method further comprises a production data logger asynchronously storing the production artifacts, wherein the production data logger is in the production environment and in communication with the machine learning pipeline.

In some cases, the production environment is a real-time inferencing environment, the production data comprises a real-time request, and the production artifacts are real-time inferencing artifacts that are saved asynchronously into a memory of the production data logger.

In some cases, the real-time request is an HTTP request, the real-time inferencing artifacts are processed to generate an HTTP response.

In some cases, the method further comprises: a testing data adapter receiving a batch dataset in a testing data format, processing the batch dataset to match the pipeline data format of the machine learning pipeline, and transmitting a reformatted batch dataset to the machine learning pipeline; the machine learning pipeline receiving and processing the reformatted batch dataset to test the machine learning model; and wherein, when the testing data adapter and the machine learning pipeline are in communication with each other, the machine learning pipeline automatically determines that the reformatted testing data is for testing the machine learning model in a batch inferencing environment.

According to some aspects, the present disclosure provides a non-transitory computer-readable medium storing computer-executable instructions. The computer-executable instructions, when executed, configure a processor to perform any of the methods described herein. For example, a non-transitory computer readable medium is provided storing computer executable instructions which, when executed by at least one computer processor, cause the at least one computer processor to carry out one or more methods for machine learning as described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud-based computing cluster of FIG. 1A, including a machine learning pipeline configured to unify a development environment and a production environment, in accordance with at least some embodiments;

FIG. 2 is a block diagram of a computer in accordance with at least some embodiments;

FIG. 3 is a schematic block diagram of a machine learning pipeline showing example processing modules, in accordance with at least some embodiments;

FIG. 4 is a schematic block diagram of a machine learning pipeline configured to unify a development environment and a production environment, and the production environment includes a batch inferencing environment and a real-time inferencing environment, in accordance with at least some embodiments;

FIG. 5 is a flowchart diagram of an example method of processing data using a training data adapter, a production data adapter and a machine learning pipeline, in accordance with at least some embodiments;

FIG. 6 is a flowchart diagram of another example method of processing data using a training data adapter, a machine learning pipeline, and an artifact data adapter, in accordance with at least some embodiments;

FIG. 7 is a flowchart diagram of another example method of processing data using a training data adapter, a machine learning pipeline, and an artifact consumer, in accordance with at least some embodiments; and

FIG. 8 is a flowchart diagram of another example method of processing data using a machine learning pipeline configured to communicate with a training data logger and a production data logger, in accordance with at least some embodiments.

### DETAILED DESCRIPTION

A computing system is provided that includes a machine learning pipeline (also herein called a unified machine learning pipeline), that communicates with one or more artifact adapters.

In many cases, developers build or develop a machine learning (ML) pipeline in a development environment to train a ML model or an artificial intelligence (AI) model, and they then build an adapted version of the ML pipeline for deployment using the trained ML model or AI model in a production environment. The term ML model is herein used to refer to both an ML model and an AI model. The deployed ML In some cases, while the trained ML model is being deployed or is production, developers will make changes or updates to the ML pipeline, such as changes to the preprocessing or to the ML model itself, or both. After testing and accepting these changes to the ML pipeline in the development environment, the developers will then manually implement the changes to the deployed ML pipeline and ML model in the production environment. Operating two ML pipelines is challenging, since the ML pipeline infrastructure and related requirements vary between a development environment and a production environment. For example, in some cases when developing and training a ML model in a development environment, different types of data are used compared to when operating a ML pipeline in a production environment. Furthermore, difference access controls and security controls are set in place for the development environment compared to the production environment. In some cases, separate compute nodes (e.g., virtual computers or processor nodes) are used for the ML pipeline in the development environment compared to the ML pipeline in the production environment. In some cases, the ML pipeline in the development environment include different modules, such as a training module, compared to the ML pipeline in a production environment, which does not include a training module.

In some cases, the type of data will cause ML pipeline infrastructure to vary. For example, in some cases, the data is a batch dataset that is updated periodically. The batch dataset is processed by a ML pipeline infrastructure that is configured for batch datasets. In some cases, the ML pipeline infrastructure that is suitable for processing batch datasets is not suitable for processing real-time on-demand data streams (e.g., a series of individual data requests). Similarly, in some cases, an ML pipeline infrastructure that is suitable for processing a real-time on-demand data stream of individual data requests, is not suitable for batch processing of batch datasets.

In some cases, tracking updates and development between an ML pipeline in the development environment and an ML pipeline in a production environment is difficult and leads to disjointed computing systems. In some cases, the difference between the production environment and the development environment grows over time as performance data metrics for the development environment are being monitored separately from performance data metrics for the production environment. Different monitoring processes may also contribute to further divergence between the development environment and the deployment environment, which could lead to further challenges and uncertainty when updating the ML pipeline in the production environment based on updates to the ML pipeline in the development environment.

In some cases, a cloud computing system is provided for machine learning, which including a ML pipeline with an artifact adaptor. In some cases, the cloud computing system includes a unified pipeline infrastructure. In some cases, the cloud computing system additionally facilitates a framework for independently training a ML model, independently executing batch inference processing using a trained ML model, and independently executing a real-time inference processing using the trained ML model.

In some cases, a cloud computing system for machine learning is provided. In some cases, the cloud computing system includes a training data adapter configured to receive training data in a training data format, process the training data to match a pipeline data format of a machine learning pipeline, and transmit reformatted training data to the machine learning pipeline. In some cases, the cloud computing system includes the machine learning pipeline includes a pipeline virtual computing machine configured to receive and process the reformatted training data to train a machine learning model in the machine learning pipeline in a development environment, and further configured to execute the machine learning model in a production environment. In some cases, the cloud computing system includes an artifact adapter configured to receive training artifacts that were produced while training the machine learning model, and process the training artifacts to update the machine learning model in the machine learning pipeline. In some cases, when the training data adapter and the machine learning pipeline are in communication with each other, the machine learning pipeline automatically determines that the reformatted training data is for training the machine learning model in the development environment. In some cases, when the artifact adapter and the machine learning pipeline are in communication with each other, the machine learning pipeline automatically determines that the processing of the training artifacts to update the machine learning model occurs in the development environment.

In some cases, the cloud computing system described herein facilitates development and training of a ML model without ML developers needing to consider deployment implementation, since the ML pipeline will automatically update the deployment of a trained ML model or updated ML pipeline, or both, after one or more conditions are satisfied. For example, the conditions include a successfully validating a ML model or receiving an indication that the ML model is ready for deployment, or both. In some cases, the indication that the ML model is ready for deployment is provided by a developer or is generated by the ML pipeline subsequent to successfully validating the ML model.

In some cases, the ML operators (which in some cases is a different team than the ML developers) are able to use deploy the ML model without understanding the ML models or writing any custom code.

In some cases, inputs into the ML pipeline and outputs from the ML pipeline are configured so that the ML pipeline is suited for both batch dataset processing and real-time data processing. In some cases, during training and batch dataset deployments, some or all artifact lineage is saved at some steps or at every step for auditability and reproducibility. In some cases, in a real-time deployment, artifacts and logs are saved asynchronously to reduce latency for obtaining a response or a result for processing a real-time request.

In some cases, artifacts include intermediate data generated from a ML model. In some cases, model artifacts include trained parameters. In some cases, artifacts include feature generation processes or feature extraction processes, or both. In some cases, artifacts include a trained ML model object. Metadata may also be included in or with the artifacts.

In some cases, a data logger interacts with the ML pipeline. In some cases, there is a training data logger in the development environment and a production data logger in the production environment. In some cases, these data loggers receive and store artifacts and related metadata in their respective development environment and their respective production environment, and the ML pipeline synchronizes the artifacts between the training data logger in the development environment and the production data logger in the production environment. In particular, the data loggers do not need to change throughout the ML pipeline, since the ML pipeline is configured to synchronize and update the data loggers when differences develop between the development environment and the production environment.

In some cases, the components that interact with ML pipeline include one or more data adapters, one or more data loggers, one or more artifact adapters, and one or more monitoring pipelines. In some cases, these components are considered “plug and play” with the ML pipeline. In particular, these components include code that will facilitate communicating with the ML pipeline, and the ML pipeline is also configured with code to automatically recognize these components and appropriately take actions that are specific to these recognized components while the ML pipeline is in communication with these recognized components. In some cases, these components are used in different computing environments, including the development environment, the batch inferencing environment, and the production environment.

In some cases, the production environment is a real-time inferencing environment. In some cases, the production environment includes a real-time inferencing environment and a batch inferencing environment.

In some cases, the one or more data loggers continue to function by logging artifacts and, in some cases, related metadata, when other components in the cloud computing system stop functioning or operating. For example, in cases where a data adapter stops functioning due to an error or by intent, or where a module in the ML pipeline may stops functioning due to an error or by intent, then the one or more data loggers continue to record and store the artifacts and the related metadata during the operations of these processes, which may be incomplete or failed. In this way, the cloud computing system can use these stored artifacts or the related metadata, or both, to improve upon the components connected to the ML pipeline or the modules in the ML pipeline, or both. In some cases, the related metadata includes an identity of the component or module associated with the artifact, or a date and time stamp associated with the artifact, or a user profile associated with the artifact, or a combination thereof.

In some cases, different access levels associated with user profiles are used to control which users (via their computing devices) are able to access the components connected to the ML pipeline, or the ML pipeline itself, or other components in the cloud computing system, or a combination thereof. For example, in some cases, a client device with a first level of access associated with a user profile, is able to read and write to all components connected to the ML pipeline, all modules within the ML pipeline, and all components associated with or indirectly related to the ML pipeline, for across multiple computing environments, including the development environment and the production environment. In another case, a second client device with a second level of access associated with a user profile, is able to read and write to all components connected to the ML pipeline, all modules within the ML pipeline, and all components associated with or indirectly related to the ML pipeline, for only the development environment, and is limited to reading data from all components connected to the ML pipeline, all modules within the ML pipeline, and all components associated with or indirectly related to the ML pipeline in the production environment. In another case, a third client device with a third level of access associated with a user profile, is unable or prevented from accessing all components connected to the ML pipeline, all modules within the ML pipeline, and all components associated with or indirectly related to the ML pipeline in the development environment, and is limited to reading data from certain components associated with or related to ML pipeline in the production environment.

In some cases, the ML pipeline is configured to have a standardized data format for inputs and a standardized data format for outputs. This standardized data format, for example, is herein called a pipeline data format. This facilitates the plug-and-play functionality and the interoperability of the ML pipeline with different components that are in communication with the ML pipeline.

In some cases, the systems and methods described herein assist with unifying the process of ML development including ML training, ML testing, and ML deployment for production in different computing environments. In some cases, the system and methods described herein provide for more complete tracking and monitoring of the development and production, and for improving security and access control.

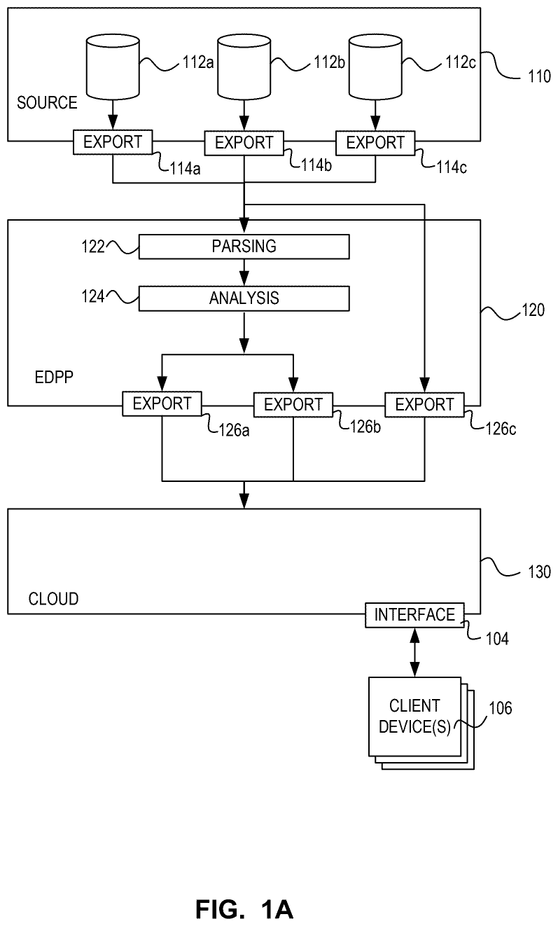

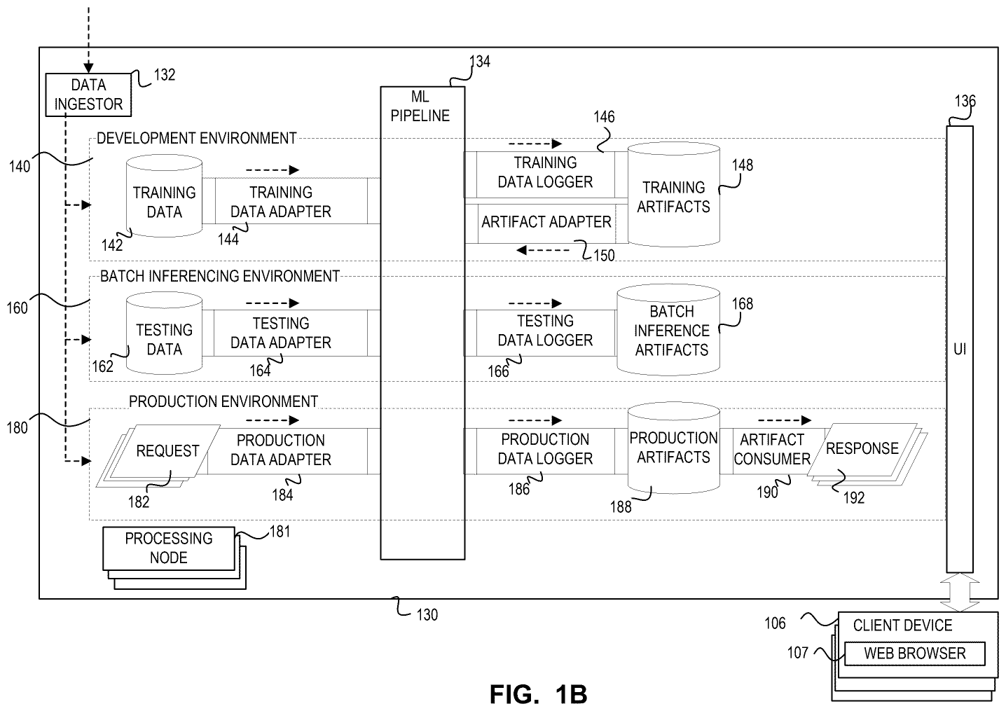

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 104, which facilitates communicating with one or more client devices 106.

In some environments, the EDPP may be omitted.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a data ingestor 132, a ML pipeline 134, components that are in communication with the ML pipeline 134, and components that are associated with or related to the ML pipeline 134. The ML pipeline 134 is configured to operate, either at different times or simultaneously, across two or more computing environments. These computing environments includes the development environment 140 and the production environment 180. In some cases, the computing environments include a batch inferencing environment 160, which could be used in a production environment or could be used in a development environment. In some cases, the batch inferencing environment 160 is used to generate inferences or predictions on a set of data, also called batch inference and/or offline inference. In some cases, the production environment is a real-time inferencing environment for processing real-time requests, and in some other cases, the production environment includes both a real-time inferencing environment and a batch inferencing environment.

In some cases, the development environment 140 includes a training adapter 144, a training data logger 146, and an artifact adapter 150 which are in communication with the ML pipeline 134. Other associated components in the development environment 140 include a training database 142 and a training artifacts database 148.

In some cases, training data is stored in a training data format in a training database 142. The training data in the training data format is transmitted to and received by the training data adapter 144, and the training data adapter 144 processes the training data to match a pipeline data format of the ML pipeline 134. The training data adapter 144 then transmits reformatted training data to the ML pipeline 134. In some cases, the training database 142 is a Structured Query Language (SQL) database.

The ML pipeline 134 receives and processes the reformatted training data to train a ML model in the ML pipeline 134. In some cases, when the training data adapter 144 and the ML pipeline 134 are in communication with each other, the ML pipeline 134 automatically determines that the reformatted training data is for training the ML model in the development environment 140. For example, this automatic determination and processing is part of the plug-and-play operation established between the ML pipeline 134 and the training data adapter 144.

In the process of the ML pipeline 134 training the ML model in the development environment 140, the ML pipeline 134 generates training artifacts. In some cases, when the training data logger and the ML pipeline 134 are in communication with each other, the ML pipeline 134 automatically transmits the training artifacts to the training data logger 146 for storage in the development environment 140. The training artifacts, for example, are stored in a training artifacts database 148. In some cases, the training artifacts database 148 is implemented as a disk storage, or a virtual disk storage in the cloud computing system. In some cases, the training data logger 146 obtains training artifacts and related metadata for storage into the training artifacts database 148.

In some cases, the artifact adapter 150 is configured to receive training artifacts that were produced while training the ML model, and to process the training artifacts to update the ML model in the ML pipeline. In some cases, when the artifact adapter 150 and the ML pipeline 134 are in communication with each other, the ML pipeline 134 automatically determines that the processing of the training artifacts to update the ML model occurs in the development environment 140.

In some cases, the training data logger 146 logs the training artifacts and the related metadata for storage in the training artifacts database 148, and then transmits back the training artifacts to the ML pipeline 134, via the artifact adapter 150. In some cases, the artifact adapter 150 processes or consumes the training artifacts to generate and provide updates to the ML pipeline 134 in the development environment 140. The ML pipeline 134 receives these updates and uses the same to automatically update the ML model or other modules in the ML pipeline 134.

In some cases, the batch inferencing environment 160 includes a testing data adapter 164 and a testing data logger 166, which are components in communication with the ML pipeline 134. Other associated components in the batch inferencing environment 160 include a testing database 162 that stores one or more batch datasets of testing data or other types of data in a batch dataset, and a batch inference artifacts database 168 that stores batch inference artifacts that are logged by the testing data logger 166.

In some cases, the testing data adapter 164 is configured to receive a batch dataset in a testing data format, process the batch dataset to match the pipeline data format of the ML pipeline 134, and transmit reformatted batch dataset to the ML pipeline 134. The ML pipeline 134 is further configured to receive and process the reformatted batch dataset to test the ML model. In some cases, when the testing data adapter 164 and the ML pipeline 134 are in communication with each other, the ML pipeline 134 automatically determines that the reformatted batch dataset is for testing the ML model in the batch inferencing environment 160. For example, this automatic determination and processing is part of the plug-and-play operation established between the ML pipeline 134 and the testing data adapter 164.

In some cases, the testing database 162 is in communication with the testing data adapter 164, and the testing database transmits the batch dataset to the testing data adapter 164. In some cases, the testing database 162 is an SQL database and, in some cases, is configured to store one or more batch datasets.

In some cases, the ML pipeline 134 is further configured to process the reformatted batch dataset using the ML model in the batch inferencing environment 160 to generate batch inference artifacts. The testing data logger 166 automatically logs the batch inference artifacts and related metadata and stores the same in the batch inference artifacts database 168. In some cases, the batch inference artifacts database 168 is virtual disk storage implemented in the cloud computing system.

In some cases, when the testing data logger 166 and the ML pipeline 134 are in communication with each other, the ML pipeline 134 automatically transmits the batch inference artifacts to testing data logger 166 for storage in the batch inferencing environment 160. For example, this automatic transmission is part of the plug-and-play operation established between the ML pipeline 134 and the testing data logger 166.

In some cases, the production environment 180 includes a production data adapter 184 and a production data logger 186, which are components in communication with the ML pipeline 134. Other associated components in the production environment 180 include a request module 182, a production artifacts database 188, an artifact consumer 190, and a response module 192.

In some cases, the production data adapter 184 is configured to receive production data in a production data format, process the production data to match the pipeline data format, and transmit the reformatted production data to the ML pipeline 134. The ML pipeline 134 receives and processes the reformatted production data to execute the ML model, thereby generating production artifacts. In some cases, the production data is a request from the request module 182. In some cases, the request module 182 stores a queue of requests for the production data adapter 184 to process.

In some cases, when the production data adapter 184 and the ML pipeline 134 are in communication with each other, the ML pipeline 134 automatically determines that the reformatted production data is to be inputted into the ML model in the production environment 180. For example, this automatic determination is part of the plug-and-play operation established between the ML pipeline 134 and the production data adapter 184.

In turn, the ML pipeline 134 receives and processes the reformatted production data to execute the ML model, which generates production artifacts. In some cases, the production artifacts include real-time inferencing artifacts.

The production data logger 186 automatically logs the production artifacts and the related metadata for storage in the production artifacts database 188. In some cases, when the production data logger and the ML pipeline 134 are in communication with each other, the ML pipeline 134 automatically transmits the production artifacts to the production data logger 186 for storage in the production environment 180. For example, this automatic transmission is part of the plug-and-play operation established between the ML pipeline 134 and the production data logger 186. In some cases, the production artifacts are stored asynchronously in order to reduce latency, so that the production artifacts can be processed by the artifacts consumer 190 to obtain a response in real-time or near real-time. In some cases, the production artifacts are initially stored in virtual memory of the production data logger 186, and then transmitted to the artifact consumer 190 for real-time processing.

In some cases, the ML pipeline 134 synchronizes the logged data from the development environment 140 and the logged data from the production environment 180. For example, the logged data from the development environment 140 includes the training artifacts stored in the training artifacts database 148 and the logged data from the production environment 180 includes the production artifacts stored in the production artifacts database 188. In some cases, the synchronization occurs when the ML pipeline detects an update to the training artifacts database 148, or an update to the production artifacts database 188, or both. In some other cases, other conditions are processed by the cloud computing system to determine if a synchronization of the logged data between the training artifacts database 148 and the production artifacts database 188 is to be executed.

In some cases, the artifacts consumer 190 receives one or more production artifacts and processes the one or more production artifacts to output a response to the request. The response is obtained by the response module 192.

In some cases, the request is a real-time request and the response is provided in real-time or near real-time. In some cases, the request is an HTTP request and the response is an HTTP response. In some cases, the HTTP response is a real-time inference provided by the ML pipeline 134.

In some cases, the cloud-based computing cluster 130 also includes a user interface (UI) 136 configured to interact with the development environment 140, the batch inferencing environment 160, or the production environment 180, or a combination thereof. For example, the UI 136 is the interface 104. The client device 106, in some cases, accesses the development environment 140, the batch inferencing environment 160, or the production environment 180, or a combination thereof, using the UI 136.

In some cases, the data ingestor 132 provides data from one or more other sources to the development environment 140, or the batch inferencing environment 160, or the production environment 180, or a combination thereof. In some cases, the training data is provided from the data ingestor 132. In some cases, the batch dataset (which may be testing data or production data) is provided by the data ingestor 132. In some cases, the one or more requests are provided by the data ingestor 132.

In some cases, components described in FIG. 1B, including the training data adapter 144, the testing data adapter 164, the production data adapter 184, the ML pipeline 134, the training data logger 146, the artifact data adapter 150, the testing data logger 166, the production data logger 186, and the artifact consumer 190, are implemented as one or more processing nodes 181 in the cloud-based computing cluster. In some cases, these components are implemented as virtual computing machines within the cloud-based computing cluster. For example, the training data adapter 144 includes a training virtual computing machine; the testing data adapter 164 includes a testing virtual computing machine; the production data adapter 184 includes a production virtual computing machine; the ML pipeline 134 includes a ML virtual computing machine; the training data logger 146 includes a training logger virtual computing machine; the artifact data adapter 150 includes an artifact adapter virtual computing machine; the testing data logger 166 includes a testing logger virtual computing machine; the production data logger 186 includes a production logger virtual computing machine; and the artifact consumer 190 includes an artifact consumer virtual computing machine.

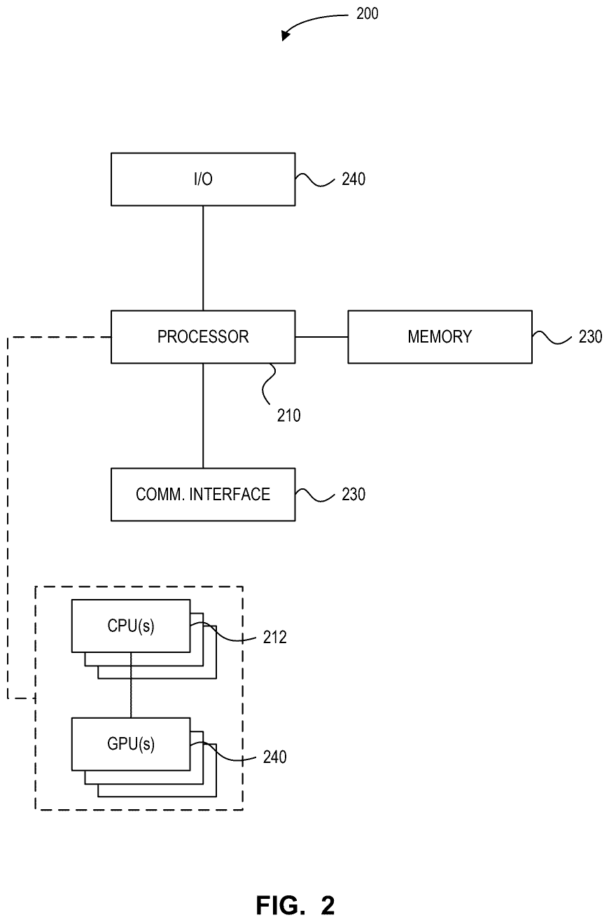

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 181 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, ML model executes neural network computations on CPU and GPU hardware, such as the system of CPUs 212 and GPUs 214.

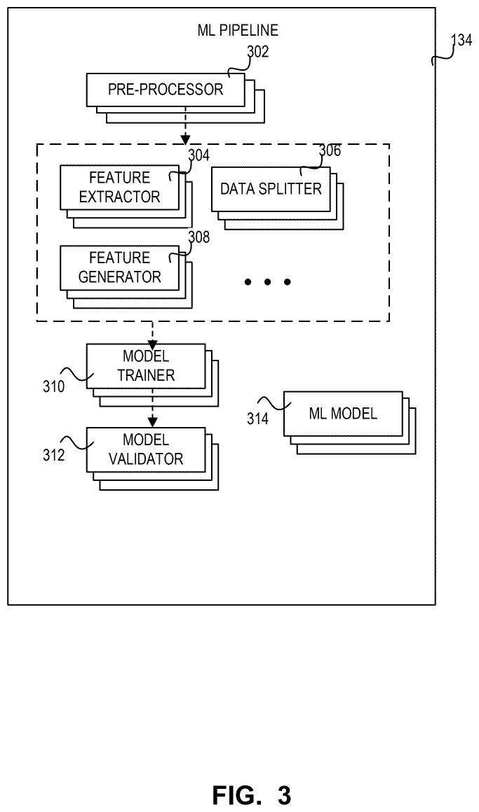

Referring now to FIG. 3, an example embodiment of a ML pipeline 134 is provided showing modules that include one or more pre-processor modules 302, one or more feature extractor modules 304, one or more data splitter modules 306, one or more feature generator modules 308, one or more model trainers 310, and one more model validators 312. The ML pipeline 134 also includes one or more ML models 314.

In some cases, different instances of modules are utilized in one computing environment (e.g., the development environment 140) compared to another computing environment (e.g., the production environment 180). In some cases, the ML module automatically synchronizes these different instances of modules. In some cases, the synchronization occurs upon detecting that one or more pre-determined conditions are satisfied.

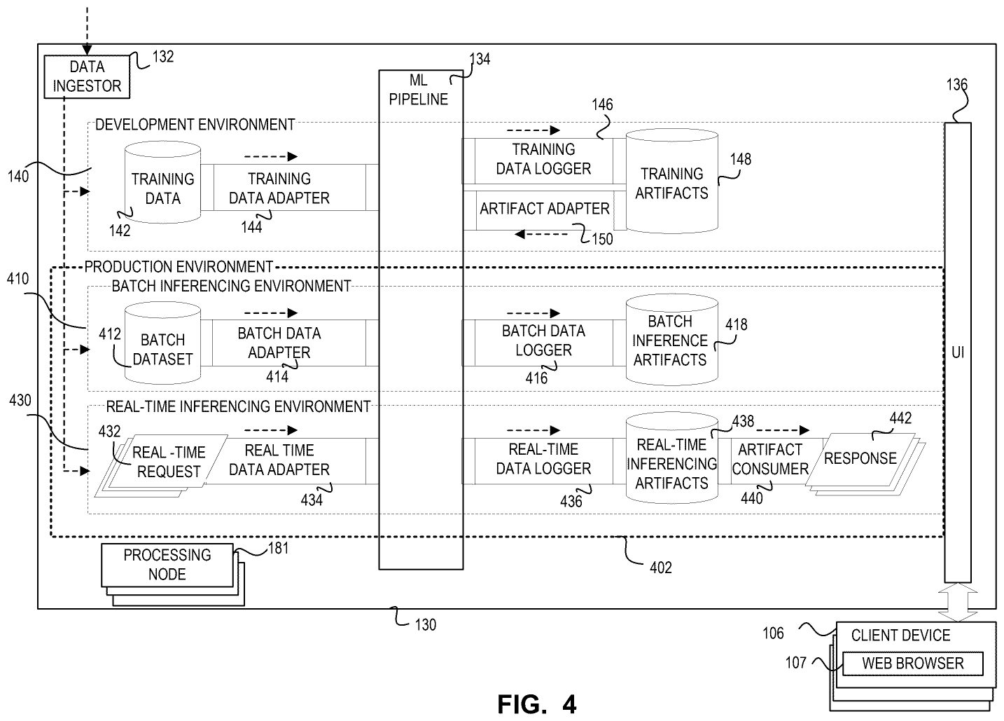

Referring now to FIG. 4, a schematic diagram of a cloud computing cluster 130 is shown according to least some other embodiments. The ML pipeline 134 is unified across the development environment 140 and a production environment 402 that includes a batch inferencing environment 410 and a real-time inferencing environment 430. The batch inferencing environment 410 in FIG. 4 is similar to the batch inferencing environment 160 shown in FIG. 1B, but the batch inferencing environment 410 in FIG. 4 is within the production environment 402 and is used process one or more batch datasets that are considered production data. The batch inferencing environment 410 in FIG. 4 includes a batch dataset database 412, a batch data adapter 414 that is in communication with the ML pipeline 134, a batch datalogger 416, and a batch inference artifacts database 418. The real-time inferencing environment 430 includes a real-time request module 432 in communication with a real-time data adapter 434, and the real-time data adapter 434 is in communication with the ML pipeline 134. Continuing in the real-time inferencing environment 430, the ML pipeline 134 is in communication with a real-time data logger 436, which logs real-time inferencing artifacts from the ML pipeline 134 and asynchronously stores the same in a real-time inferencing artifacts database 438. An artifact consumer 440 processes one or more real-time artifacts to generate a response to the real-time request. The response is transmitted to a response module 442.

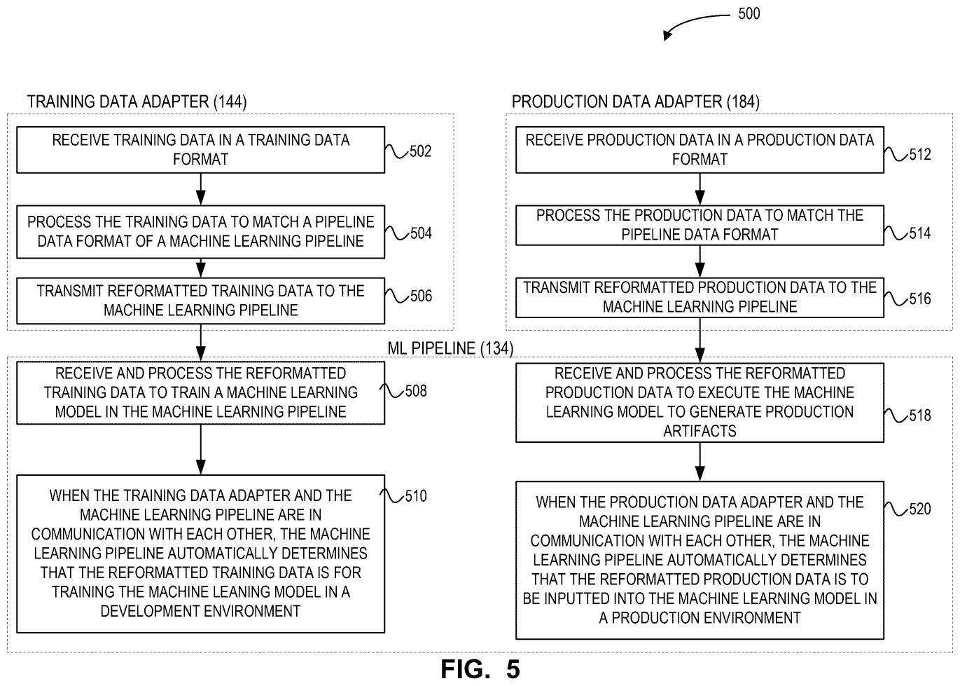

Referring to FIG. 5, a computing process 500 for a ML pipeline with one or more data adapters is provided.

Block 502: A training data adapter receives training data in a training data format.

Block 504: The training data adapter processes the training data to match a pipeline data format of a ML pipeline.

Block 506: The training data adapter transmits the reformatted training data to the ML pipeline.

Block 508: The ML pipeline receives and processes that reformatted training data to train a ML model in the ML pipeline.

Block 510: When the training data adapter in the ML pipeline are in communication with each other, the ML pipeline automatically determines that the reformatted training data is for training the ML model in a development environment.

Block 512: The production data app doctor receives production data in a production data format.

Block 514: The production data adapter processes the production data to match the pipeline data format.

Block 516: The production data adapter transmits reformatted production data to the ML pipeline.

Block 518: The ML pipeline receives and processes that reformatted production data to execute the ML model to generate production artifacts.

Block 520: When the production data adapter and the ML pipeline are in communication with each other, the ML pipeline automatically determines that the reformatted production data is to be inputted into the ML model in a production environment.

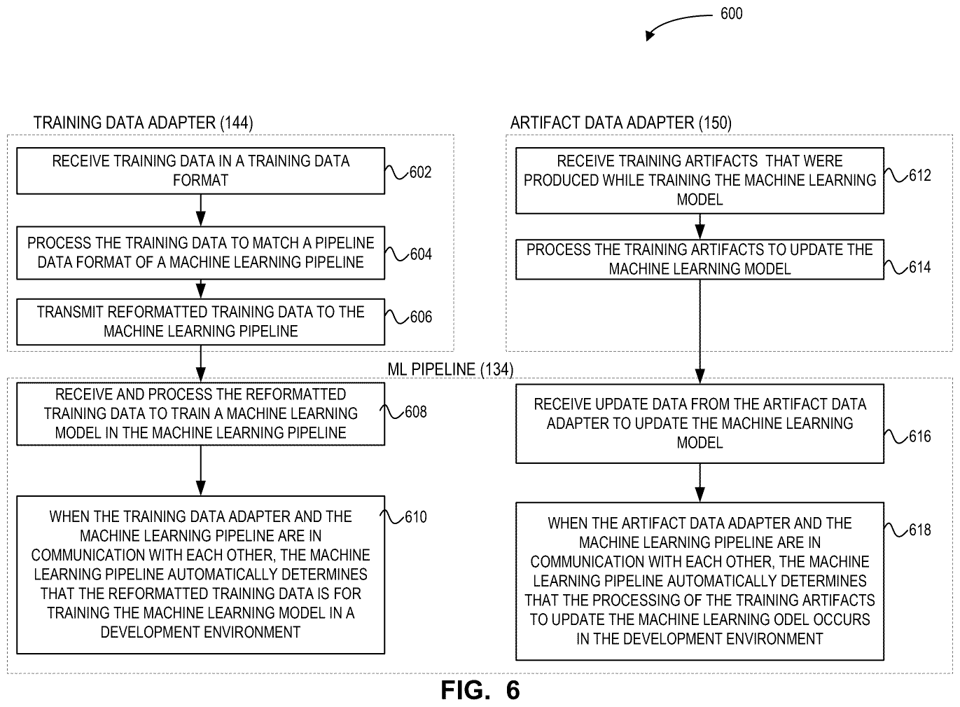

Referring to FIG. 6, a computing process 600 for a ML pipeline with an artifact adapter is provided.

Block 602: The training data adapter receives training data in a training data format.

Block 604: The training data adapter processes the training data to match a pipeline data format of a ML pipeline.

Block 606: The training data adapter transmits reformatted training data to the ML pipeline.

Block 608: The ML pipeline receives and processes the reformatted training data to train a ML model in the ML pipeline.

Block 610: When the training data adapter and ML pipeline are in communication with each other, the ML pipeline automatically determines that the reformatted training data is for training the ML model in a development environment.

Block 612: the artifact data adapter receives training artifacts that were produced while training the ML model.

Block 614: The artifact that adapter processes the training artifacts to update the ML model.

Block 616: The ML pipeline receives update data from artifact data adapter to update the ML model.

Block 618: When the artifact data adapter and the ML pipeline are in communication with each other, the ML pipeline automatically determines that the processing of the training artifacts to update the ML model occurs in the development environment.

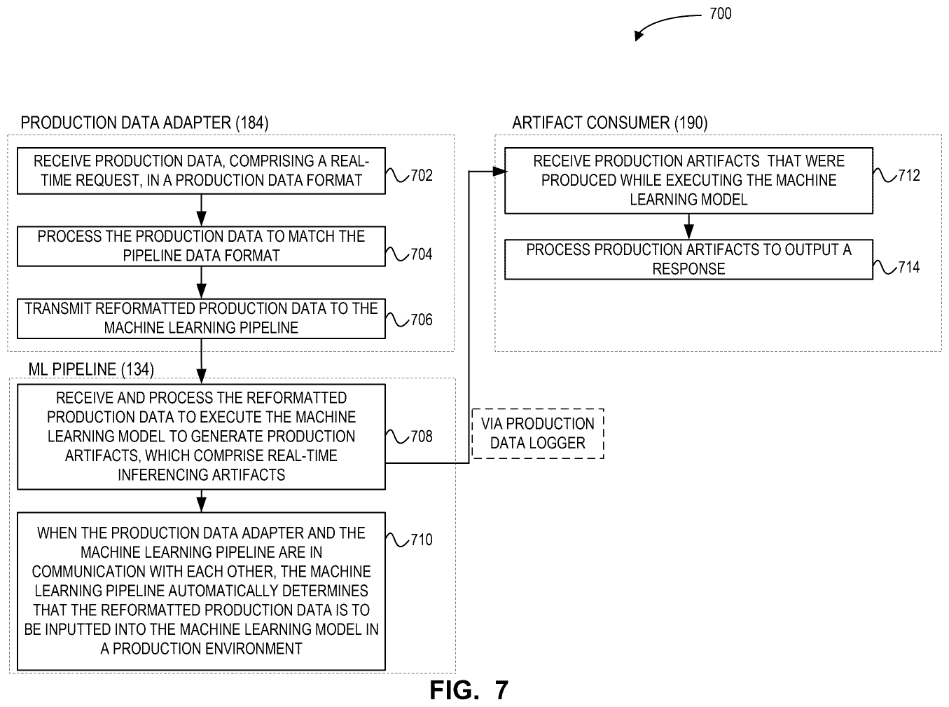

Referring to FIG. 7, a computing process 700 for a ML pipeline with an artifact consumer is provided.

Block 702: The production data adapter receives production data which comprises a real time request in a production data format.

Block 704: The production data adapter processes the production data to match the pipeline data format.

Block 706: The production data adapter transmits reformatted production data to the ML pipeline.

Block 708: The ML pipeline receives and processes that reformatted production data to execute the ML model to generate production artifacts which comprise real-time inferencing artifacts.

Block 710: When the production adapter and ML pipeline are in communication with each other, that ML pipeline automatically determines that the reformatted production data is to be inputted into ML model in a production environment.

Block 712: The artifact consumer receives production artifacts that were produced while executing the ML model.

Block 714: The artifact consumer processes the production artifacts to output a response.

In some cases, the artifact consumer obtains the production artifacts as a result of processes executed by a production data logger in communication with the ML pipeline.

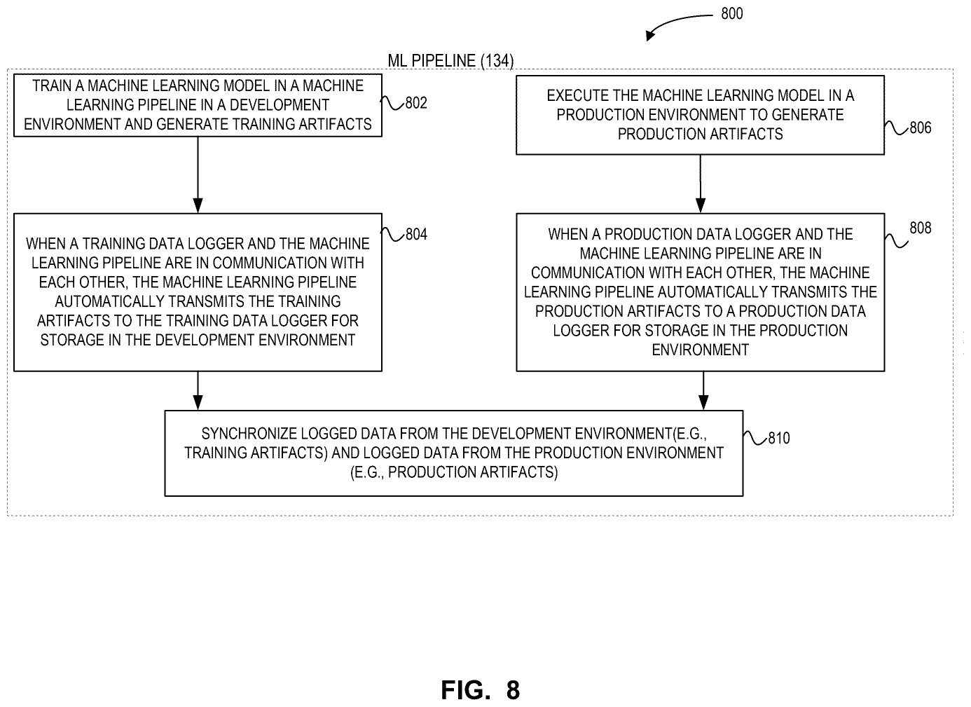

Referring to FIG. 8, a computing process 800 for a ML pipeline with a logging adapter is provided.

Block 802: The ML pipeline trains a ML model in a ML pipeline in a development environment and generates training artifacts.

Block 804: When a training data logger and the ML pipeline are in communication with each other, the ML pipeline automatically transmits the training artifacts to the training data logger for storage in the development environment.

Block 806: The ML pipeline executes the ML model in a production environment to generate production artifacts.

Block 808: When a production data logger and the ML pipeline are in communication with each other, the ML pipeline automatically transmits the production artifacts to a production data logger for storage in the production environment.

Block 810: The ML pipeline synchronizes logged data from the development environment (e.g., training artifacts) and logged data from the production environment (e.g., production artifacts).

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A cloud computing system for machine learning, the cloud computing system comprising:
a training data adapter configured to receive training data in a training data format, process the training data to match a pipeline data format of a machine learning pipeline, and transmit reformatted training data to the machine learning pipeline;
the machine learning pipeline comprising a pipeline virtual computing machine configured to receive and process the reformatted training data to train a machine learning model in the machine learning pipeline in a development environment, and further configured to execute the machine learning model in a production environment;
an artifact adapter configured to receive training artifacts that were produced while training the machine learning model, and process the training artifacts to update the machine learning model in the machine learning pipeline;
wherein, when the training data adapter and the machine learning pipeline are in communication with each other, the machine learning pipeline automatically determines that the reformatted training data is for training the machine learning model in the development environment; and
wherein, when the artifact adapter and the machine learning pipeline are in communication with each other, the machine learning pipeline automatically determines that the processing of the training artifacts to update the machine learning model occurs in the development environment.

2. The cloud computing system of claim 1, wherein the machine learning pipeline is configured to synchronize logged data from the development environment and logged data from the production environment; and wherein the logged data from the development environment comprises the training artifacts, and the logged data from the production environment comprises production artifacts generated by the machine learning model.

3. The cloud computing system of claim 2, further comprising a training data logger in the development environment and in communication with the machine learning pipeline, the training data logger configured to store the training artifacts.

4. The cloud computing system of claim 3, wherein the training data logger transmits back the training artifacts to the artifact adapter.

5. The cloud computing system of claim 2, further comprising:
a production data adapter comprising a production virtual computing machine configured to receive production data in a production data format, process the production data to match the pipeline data format, and transmit reformatted production data to the machine learning pipeline;
wherein the machine learning pipeline is further configured to receive and process the reformatted production data using the machine learning model to generate production artifacts in the production environment; and
wherein, when the production data adapter and the machine learning pipeline are in communication with each other, the machine learning pipeline automatically determines that the reformatted production data is to be inputted into the machine learning model in the production environment.

6. The cloud computing system of claim 5, further comprising:
a production data logger in the production environment and in communication with the machine learning pipeline, the production data logger configured to asynchronously store the production artifacts.

7. The cloud computing system of claim 6, wherein the production environment is a real-time inferencing environment, the production data comprises a real-time request, and the production artifacts are real-time inferencing artifacts that are saved asynchronously into a memory of the production data logger.

8. The cloud computing system of claim 7, wherein the real-time request is an HTTP request, the real-time inferencing artifacts are processed to generate an HTTP response.

9. The cloud computing system of claim 1, further comprising:
a testing data adapter comprising a testing virtual computing machine configured to receive a batch dataset in a testing data format, process the batch dataset to match the pipeline data format of the machine learning pipeline, and transmit a reformatted batch dataset to the machine learning pipeline;
the machine learning pipeline further configured to receive and process the reformatted batch dataset to test the machine learning model; and
wherein, when the testing data adapter and the machine learning pipeline are in communication with each other, the machine learning pipeline automatically determines that the reformatted testing data is for testing the machine learning model in a batch inferencing environment.

10. The cloud computing system of claim 9, wherein the machine learning pipeline is further configured to process the reformatted batch dataset using the machine learning model in the batch inferencing environment to generate batch inference artifacts.

11. A method for machine learning, the method executed in a computing environment comprising one or more processors, a communication interface, and memory, and the method comprising:
a training data adapter receiving training data in a training data format, processing the training data to match a pipeline data format of a machine learning pipeline, and transmitting reformatted training data to the machine learning pipeline;
the machine learning pipeline receiving and processing the reformatted training data to train a machine learning model in the machine learning pipeline in a development environment, and further executing the machine learning model in a production environment;
an artifact adapter receiving training artifacts that were produced while training the machine learning model, and processing the training artifacts to update the machine learning model in the machine learning pipeline;
wherein, when the training data adapter and the machine learning pipeline are in communication with each other, the machine learning pipeline automatically determines that the reformatted training data is for training the machine learning model in the development environment; and
wherein, when the artifact adapter and the machine learning pipeline are in communication with each other, the machine learning pipeline automatically determines that the processing of the training artifacts to update the machine learning model occurs in the development environment.

12. The method of claim 11, further comprising the machine learning pipeline synchronizing logged data from the development environment and logged data from the production environment; and wherein the logged data from the development environment comprises the training artifacts, and the logged data from the production environment comprises production artifacts generated by the machine learning model.

13. The method of claim 12, further comprising a training data logger storing the training artifacts, wherein the training data logger is in the development environment and in communication with the machine learning pipeline.

14. The method of claim 13, further comprising the training data logger transmitting back the training artifacts to the artifact adapter.

15. The method of claim 12, further comprising:
a production data adapter receiving production data in a production data format, processing the production data to match the pipeline data format, and transmitting reformatted production data to the machine learning pipeline;
the machine learning pipeline receiving and processing the reformatted production data using the machine learning model to generate production artifacts in the production environment; and
wherein, when the production data adapter and the machine learning pipeline are in communication with each other, the machine learning pipeline automatically determines that the reformatted production data is to be inputted into the machine learning model in the production environment.

16. The method of claim 15, further comprising a production data logger asynchronously storing the production artifacts, wherein the production data logger is in the production environment and in communication with the machine learning pipeline.

17. The method of claim 16, wherein the production environment is a real-time inferencing environment, the production data comprises a real-time request, and the production artifacts are real-time inferencing artifacts that are saved asynchronously into a memory of the production data logger.

18. The method of claim 17, wherein the real-time request is an HTTP request, the real-time inferencing artifacts are processed to generate an HTTP response.

19. The method of claim 11, further comprising:
a testing data adapter receiving a batch dataset in a testing data format, processing the batch dataset to match the pipeline data format of the machine learning pipeline, and transmitting a reformatted batch dataset to the machine learning pipeline;
the machine learning pipeline receiving and processing the reformatted batch dataset to test the machine learning model; and
wherein, when the testing data adapter and the machine learning pipeline are in communication with each other, the machine learning pipeline automatically determines that the reformatted testing data is for testing the machine learning model in a batch inferencing environment.

20. A non-transitory computer readable medium storing computer executable instructions which, when executed by at least one computer processor, cause the at least one computer processor to carry out a method for machine learning, the method comprising:
a training data adapter receiving training data in a training data format, processing the training data to match a pipeline data format of a machine learning pipeline, and transmitting reformatted training data to the machine learning pipeline;
the machine learning pipeline receiving and processing the reformatted training data to train a machine learning model in the machine learning pipeline in a development environment, and further executing the machine learning model in a production environment;
an artifact adapter receiving training artifacts that were produced while training the machine learning model, and processing the training artifacts to update the machine learning model in the machine learning pipeline;
wherein, when the training data adapter and the machine learning pipeline are in communication with each other, the machine learning pipeline automatically determines that the reformatted training data is for training the machine learning model in the development environment; and
wherein, when the artifact adapter and the machine learning pipeline are in communication with each other, the machine learning pipeline automatically determines that the processing of the training artifacts to update the machine learning model occurs in the development environment.
